(19) United States
(12) Patent Application Publication
(10) Pub. No.: US 2002/0085378 A1
(43) Pub. Date: Jul. 4, 2002

(54) Connected light bulbs for water-tube light decoration

(76) Inventors: Chun-Teng Lee, Taipei City (TW); Te-Hui Lin, Taipei City (TW)

Correspondence Address: LEE, CHUN-TENG, P.O. BOX 7-820, TAIPEI, TW

(21) Appl. No.: 09/753,959

(22) Filed: Jan. 4, 2001

(51) Int. Cl. F21S 2/00

(52) U.S. Cl. 362/227

(57) ABSTRACT

The present invention relates to a series of connected light bulbs for water-tube decoration, characterized in that the serial connection of light bulb is accomplished by stamping a metallic board into a serial connection of conductive legs for the light emitting diode as a whole. After wrapping and fixing the light emitting plate in position by plastic material, it only needs to directly pull the conductive legs apart with appropriate intervals, and the series of connected light bulbs according to the present invention is formed. Such connection of the conductive legs of the bulb gives a whole piece structure with conductivity of high precision and enhances the stability of the light emission to extend the life of its usage and to show its industrial practicability and value.

### BACKGROUND OF THE INVENTION

1. Field of the Invention

The present invention relates to a series of connected light bulbs for water-tube light decoration, more particularly to a series of connected light bulbs by stamping a metallic board into a serial connection of conductive legs for the light emitting diode as a whole.

2. Description of he Prior Art

The assembly of the traditional water-tube lamp is by implanting many light bulbs that is connected in series into a plastic tube. Since the structure of such light bulb must have a core member having a tungsten filament mounted between two conductive legs of the core member, and a vacuum lampshell to allow light emission in the oxygen free shell. It is obvious that such lamp has shortcomings of complicated structure, high costs for material and labor, not easy to manufacture, and furthermore the life of the light emitting object is very limited and the light source is not stable. As we know, the conductive legs are pulled apart and then pairs of them are connected to the post of the core member by soldering. However, the oxidation will make the conductivity unstable and easily causes short circuit phenomenon. Therefore the present invention is designed to improve these shortcomings.

### SUMMARY OF THE INVENTION

In view of the shortcomings and inconvenience of the prior art mentioned above, which are the subjects of improvements for a long time, hence the inventor of the present invention based on years of experience accumulated from the engagement in the related industry conducted extensive research to resolve the foregoing shortcomings and invented the present invention.

Therefore, the primary objective of the present invention is to provide a series of connected light bulbs for water-tube decoration, characterized in that the serial connection of light bulb is accomplished by stamping a metallic board into a serial connection of conductive legs for the light emitting diode as a whole. After wrapping and fixing the light emitting plate in position by plastic material, it only needs to directly pull the conductive legs apart with appropriate intervals, and the series of connected light bulbs according to the present invention is formed. Such connection of the conductive legs of the bulb has demonstrated its industrial practicability and value.

Another objective of the present invention is to provide a series of connected light bulbs for water-tube decoration, especially such connection of the conductive legs of the bulb gives a whole piece structure with conductivity of high precision and enhances the stability of the light emission to extend the life of its use and to show its industrial practicability and value.

Another further objective of the present invention is to provide a series of connected light bulbs for water-tube decoration to enhance (by the innovation of the present invention) the traditional complicated structure having many components that is difficulty to produce or cost more for the manufacture, and having the shortcoming of poor conductivity. Mass production with standardized manufacture specification give a high yield, and further to drastically reduce the labor cost of the production line and shows its industrial practicability and value.

To make it easier for our examiner to understand the objective of the invention, structure, innovative features, and performance, we use a preferred embodiment together with the attached drawings for the detailed description of the invention.

### BRIEF DESCRIPTION OF THE DRAWINGS

Other objects, features, and advantages of the invention will become apparent from the following detailed description of the preferred but non-limiting embodiment. The description is made with reference to the accompanying drawings, in which:

FIG. 1 shows the schematic diagram of the serial connection of light bulbs for the water-tube light decoration according to the present invention.

FIG. 2 shows the connected member of the light emitting plates for the connected light bulbs according to a preferred embodiment of the present invention.

FIG. 3 shows the connection of conductive legs completed by wrapping the light emitting plate in high frequency according to a preferred embodiment of the present invention.

FIG. 4 shows the illustrative diagram of the direct serial connection between the intervals of the connection according to a preferred embodiment of the present invention.

### DELTAILED DESCRIPTION OF THE PREFERRED EMBODIMENT

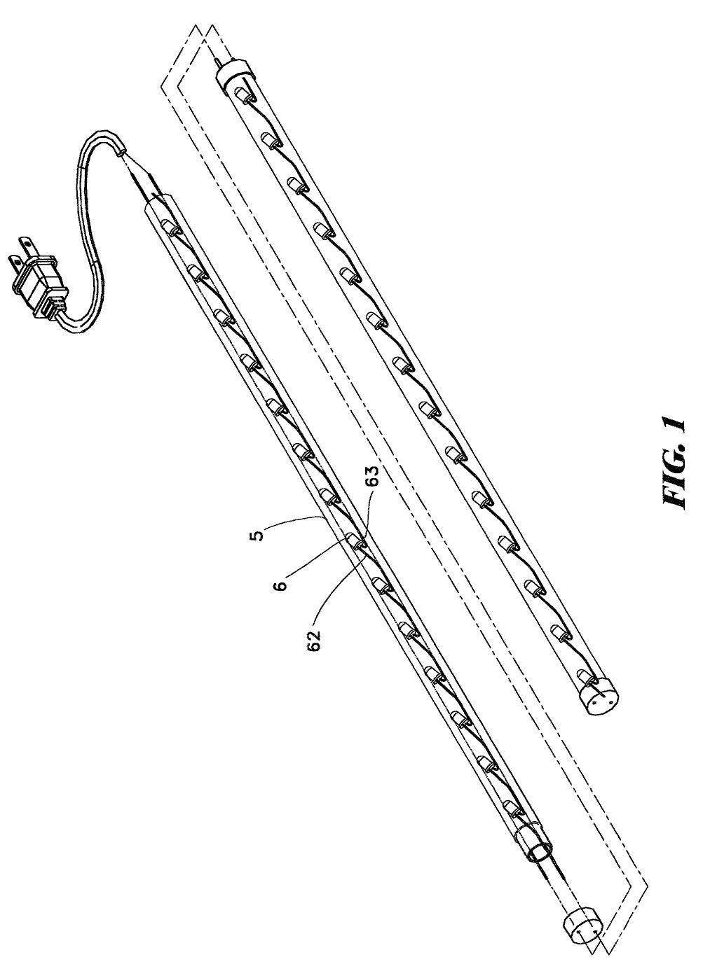

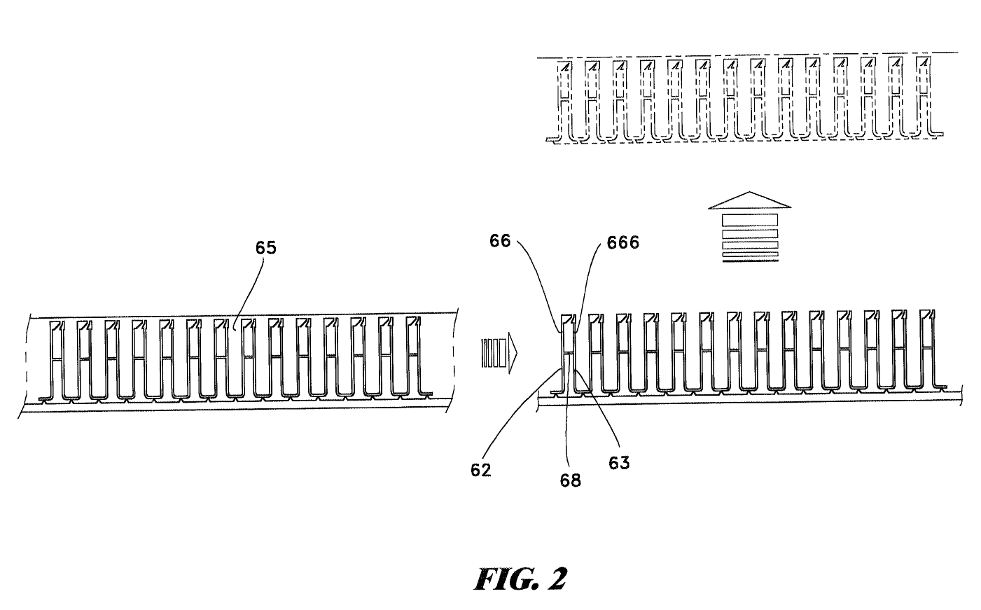

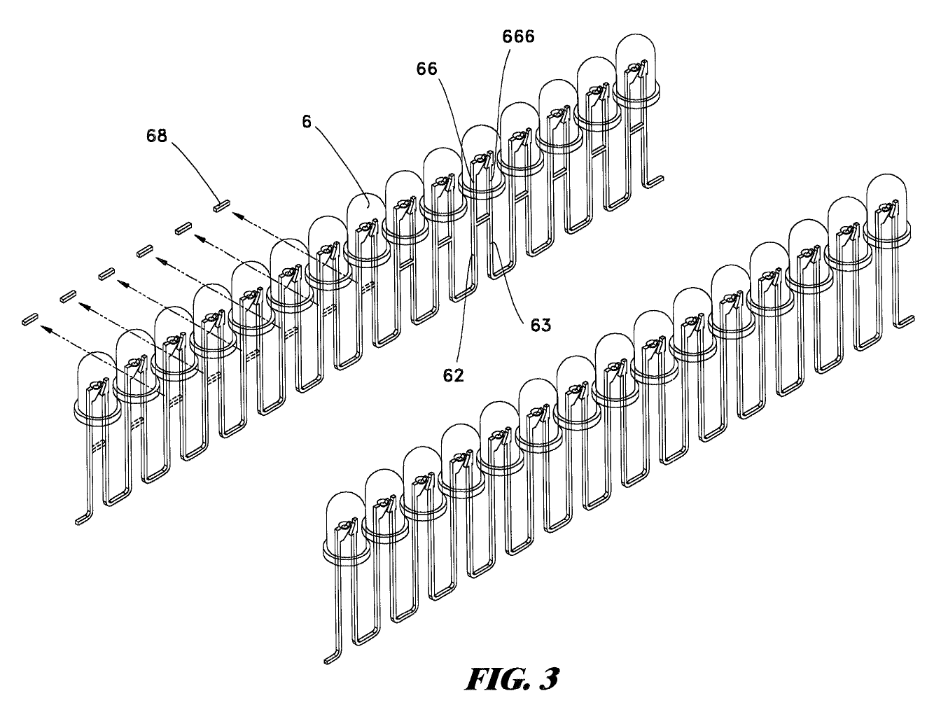

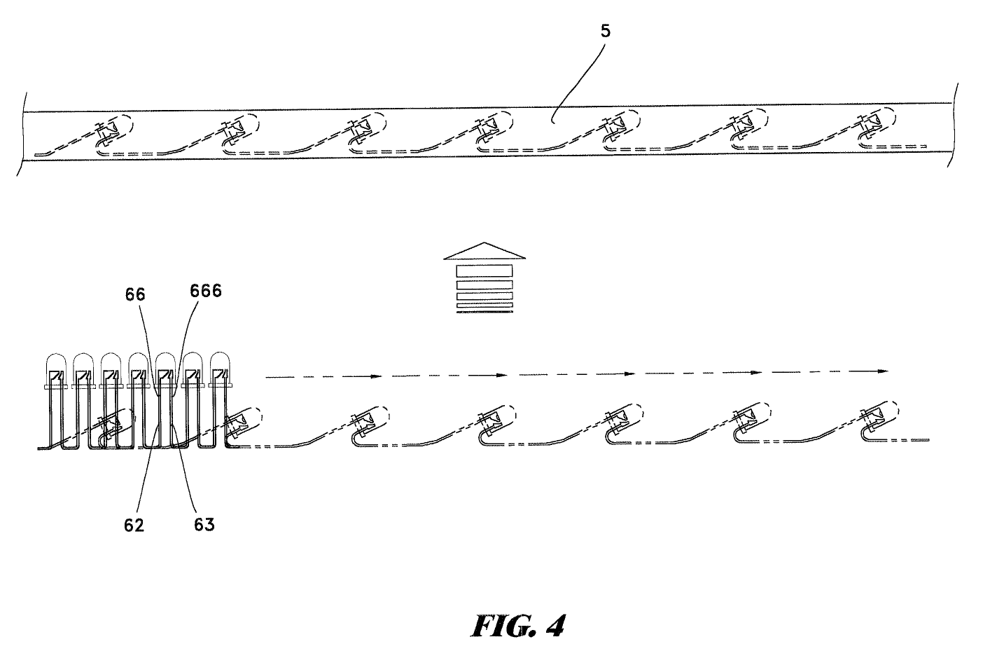

Please refer to FIGS. 1 to 4. The connected light bulbs for water-tube decoration of the present invention comprises a serially connected light emitting diode 6 being implanted into the internal diameter of the plastic tube 5; the diode member is a light emitting plate wrapped inside the bulb of the diode member by plastic material, and two end plates 62, 63 of the conductive legs being extended from both side of the light emitting plate, and the serial connection of the bulbs in a row is formed by the two end plates of each light emitting plate in which two corresponding light emitting plates 66, 666 remain after the first time stamping and edge trimming of a metallic plate 65. A gap between the conductive legs at the lower portion of the diode plates is reserved for a connecting plate 68. Such arrangement disconnects the connecting plate to facilitate the end plates of the conductive legs between bulbs to form a whole piece when the diode plate is wrapped with by plastic material inside by means of high frequency. It only needs to directly pull the end plate of the conductive leg disposed between the wrapped bulbs apart with an appropriate interval, and then the end plates of the two legs between bulbs are of a whole piece. Therefore, it gives a high precision conductivity to the power supply, and enhances the stability of light emission to extend the life of its usage and to show its industrial practicability and value.

The connected light bulbs for decoration according to the present invention totally change the traditional complex structure of the light bulbs, complicated manufacturing process, and high cost and do not have the unstable and energy consuming tungsten filament, limited life for the light source, and the short circuit problem arisen from the oxidation of the soldered conductive legs between bulbs

The inventor of the present invention based on years of experience in the related industry conducted extensive research to enhance the dynamic artificial landscape herein, which is hereby submitted for patent application.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

I claim:

1. A connected light bulb for water-tube decoration, characterized in that the connection of a plurality of light bulbs being connected in series and a pair of light emitting plates, each comprising a conductive leg being remained after the first time stamping and edge trimming of a metallic plate, and a gap between the conductive legs at the lower portion of the diode plates is reserved for a connecting plate, and such arrangement disconnects the connecting plate to facilitate the end plates of the conductive legs between bulbs to form a whole piece when the diode plate is wrapped with by plastic material inside by means of high frequency, and such assembly only needs to directly pull the end plate of the conductive leg disposed between the wrapped bulbs apart with an appropriate interval, and then the end plates of the two legs between bulbs are of a whole piece.
